(19) United States
(12) Patent Application Publication
(10) Pub. No.: US 2023/0313869 A1
(43) Pub. Date: Oct. 5, 2023

(54) ANTI-ROTATION DEVICE FOR VEHICLE STEERING SYSTEM

(71) Applicant: Steering Solutions IP Holding Corporation, Saginaw, MI (US)

(72) Inventors: Christopher R. Case Myers, Freeland, MI (US); Eric D. Pattok, Frankenmuth, MI (US); John S. Beam, Freeland, MI (US); Travis L. Palmer, Frankenmuth, MI (US)

(21) Appl. No.: 18/128,064

(22) Filed: Mar. 29, 2023

Related U.S. Application Data
(60) Provisional application No. 63/330,084, filed on Apr. 12, 2022.
(60) Provisional application No. 63/326,160, filed on Mar. 31, 2022.

(51) Int. Cl. B62D 5/04; F16H 25/24

(52) U.S. Cl. CPC F16H 25/24; B62D 5/0445; F16H 25/2204

(57) ABSTRACT

A linear translating assembly includes a housing. The linear translating assembly also includes a linear translating component moveable in an axial direction, wherein at least a portion of the length of the linear translating component is disposed within the housing. The linear translating assembly further includes an anti-rotation device. The anti-rotation device includes an inner clamshell assembly at least partially surrounding the linear translating component at a mounting location of the linear translating component. The anti-rotation device also includes an outer clamshell assembly at least partially surrounding the inner clamshell assembly. The anti-rotation device is disposed within the housing and is axially fixed to the linear translating component at the mounting location in a non-rotational manner relative to the linear translating component, wherein interaction between the anti-rotation device and the housing prevents rotation of the linear translating component.

### CROSS-REFERENCE TO RELATED APPLICATIONS

This application claims the benefits of priority to U.S. Provisional Pat. Application Serial No. 63/326,160, filed Mar. 31, 2022, and U.S. Provisional Pat. Application Serial No. 63/330,084, filed Apr. 12, 2022, the disclosures of which are each incorporated by reference herein in their entireties.

### BACKGROUND

Various electric power steering (EPS) systems have been developed for assisting an operator with vehicle steering. One type of EPS system is referred to as a rack electric power steering (REPS) system. A REPS system utilizes an electric motor that drives a ball nut and rack. The rack teeth are engaged with a pinion. The pinion complements a driving feature that is rotated in response to rotation of a portion of the steering column by an operator, with the driving feature providing a steering input to the rack. The driving feature may be integrated with the steering column (i.e., single pinion electric power steering system) or may be a driving pinion (i.e., dual pinion electric power steering system), for example. OEMs may be interested in removing the pinion for better packaging and cost during development of steer-by-wire gear systems.

In addition to REPS systems discussed above, column EPS (CEPS) systems are analyzed for potential improvements related to packaging and cost.

### SUMMARY

According to one aspect of the disclosure, a linear translating assembly includes a housing. The linear translating assembly also includes a linear translating component moveable in an axial direction, wherein at least a portion of the length of the linear translating component is disposed within the housing. The linear translating assembly further includes an anti-rotation device. The anti-rotation device includes an inner clamshell assembly at least partially surrounding the linear translating component at a mounting location of the linear translating component. The anti-rotation device also includes an outer clamshell assembly at least partially surrounding the inner clamshell assembly. The anti-rotation device is disposed within the housing and is axially fixed to the linear translating component at the mounting location in a non-rotational manner relative to the linear translating component, wherein interaction between the anti-rotation device and the housing prevents rotation of the linear translating component.

According to another aspect of the disclosure, an anti-rotation device for a linear translating component includes an inner clamshell assembly at least partially surrounding the linear translating component at a mounting location of the linear translating component, wherein the inner clamshell assembly comprises a first inner clamshell element and a second inner clamshell element. The anti-rotation device also includes an outer clamshell assembly at least partially surrounding the inner clamshell assembly, wherein the outer clamshell assembly comprises a first outer clamshell element and a second outer clamshell element, the first and second outer clamshell elements each surrounding a portion of the inner clamshell assembly. The anti-rotation device further includes at least one spring element disposed between the inner clamshell assembly and the outer clamshell assembly to de-lash the anti-rotation device.

According to yet another aspect of the disclosure, a steer-by-wire steering system for a vehicle includes a housing. The steer-by-wire steering system also includes a ball screw moveable in an axial direction and at least partially disposed within the housing. The steer-by-wire steering system further includes an anti-rotation device disposed proximate an outer surface of the ball screw at a mounting portion of the ball screw, wherein the anti-rotation device having at least one split to define a plurality of segments of the anti-rotation device, the plurality of segments flexible relative to each other, the anti-rotation device axially and rotationally fixed relative to the ball screw, the ball screw having a non-circular outer surface to interact with the housing in a non-rotatable manner. The steer-by-wire steering system yet further includes a biasing element in contact with the anti-rotation device to bias the plurality of segments radially outward.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates a steering assembly with an electric power steering assist system;

FIG. 2 is a perspective view of a portion of the electric power steering system with a housing surrounding a linear translating component;

FIG. 3 is a perspective view of the electric power steering system with a portion of the housing removed to illustrate a sleeve of an anti-rotation device;

FIG. 4 is a perspective view of the sleeve of the anti-rotation device and the linear translating component;

FIG. 5 is a perspective view of the anti-rotation device in an assembled condition with a portion of the sleeve removed;

FIG. 6 is a perspective view of the anti-rotation device in a disassembled condition;

FIG. 7 is a perspective view of the anti-rotation device in an assembled condition with the sleeve removed;

FIG. 8 is a cross-sectional, end view of the anti-rotation device assembled within the housing of the electric power steering system; and

FIG. 9 is a perspective view of the linear translating component having a knurled portion;

FIG. 10 is a perspective view of the anti-rotation device according to another aspect of the disclosure for the linear translating component of FIG. 9;

FIG. 11 is a perspective view of the anti-rotation device according to another aspect of the disclosure; and

FIG. 12 is an end view of the anti-rotation device of FIG. 11.

### DETAILED DESCRIPTION

Referring now to the Figures, the embodiments described herein are used in conjunction with a steering assembly of a vehicle, such as a car, truck, sport utility vehicle, crossover, mini-van, marine craft, aircraft, all-terrain vehicle, recreational vehicle, or other suitable vehicles which include various steering system schemes. As discussed herein, an electric power steering (EPS) system, including a steer-by-wire system, for example, includes an anti-rotation device where a pinion is not used in the steering system. The anti-rotation device resists rotation of a linear translating component. Such rotation is induced by the loading of an actuating component in contact with the linear translating component, such as the threading of a ball nut, for example.

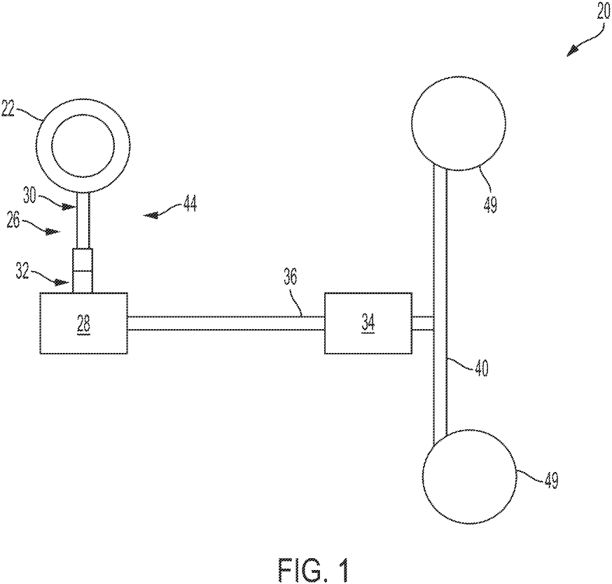

Referring initially to FIG. 1, the power steering system 20 is generally illustrated. The power steering system 20 may be configured as a driver interface steering system, an autonomous driving system, or a system that allows for both driver interface and autonomous steering. The steering system may include an input device 22, such as a steering wheel, wherein a driver may mechanically provide a steering input by turning the steering wheel. A steering column 26 extends along an axis from the input device 22 to an output assembly 28. The steering column 26 may include at least two axially adjustable parts, for example, a first jacket 30 and a second jacket 32 that are axially adjustable with respect to one another. The embodiments disclosed herein are utilized in steering systems where the output assembly 28 is in operative communication (e.g., steer-by-wire, autonomous system, etc.) with an actuator 34 that is coupled to a linear translating component 40. The output assembly 28 has wired communication 36 with the actuator 34. Actuator 34 drives the linear translating component 40 to provide steering control of the vehicle.

The linear translating component 40 is any component having a generally cylindrical cross-section along at least a portion of the length thereof and is driven in a substantially linear manner to effectuate adjustment of vehicle road wheels 49. In some embodiments, the linear translating component 40 is a ball screw. In other embodiments, the linear translating component 40 is a lead screw. The preceding examples are not limiting of the linear translating component 40.

In prior steer-by-wire steering systems, a pinion is utilized on an outer surface of the linear translating component 40 (e.g., “rack”) to provide steering input control of the linear translating component 40 and anti-rotation reaction forces on the linear translating component 40. However, the pinion and associated required components (e.g., pinion upper and lower bearing, rack bearing, adjuster plug, lower rotor, and rack teeth, etc.) may be undesirable in certain steering systems based on packaging requirements, cost, and manufacturing complexity, for example. The embodiments of an anti-rotation device disclosed herein provide the anti-rotation benefits of the previously required pinion, while eliminating the numerous components noted above. The above-referenced steering input control of the linear translating component 40 with a pinion is unnecessary in a steer-by-wire steering system.

Although the embodiments disclosed herein are described in connection with an EPS system located at the lower/forward portion of a steering column and system, it is to be understood that EPS systems providing assistance at other column locations may benefit from the disclosed embodiments. In particular, a column EPS (CEPS) system may utilize the embodiments disclosed herein. Furthermore, the anti-rotation device disclosed herein may be used in any system that relies on a substantially cylindrical component driven in a translating manner and which requires or would benefit from limitation of rotation.

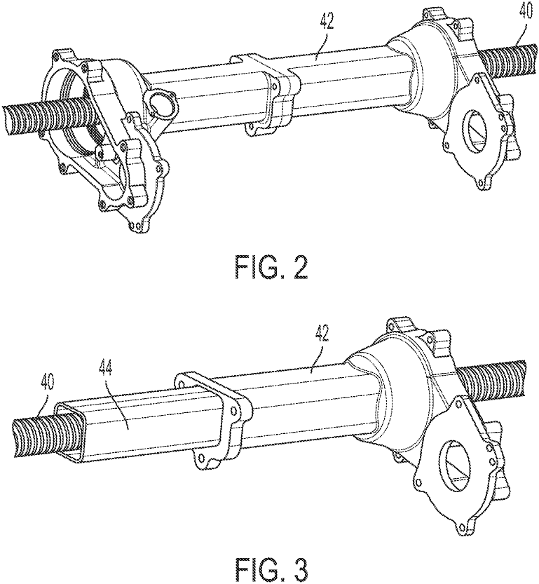

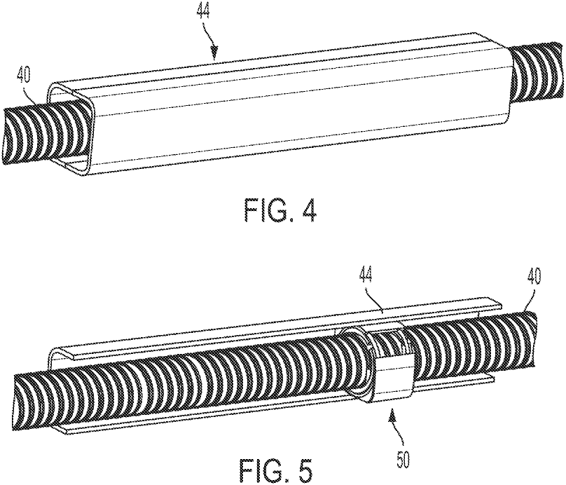

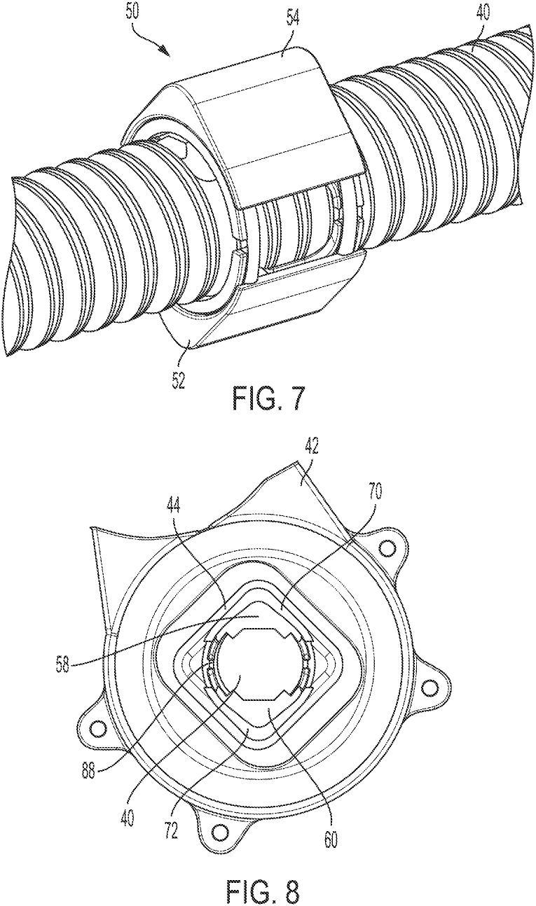

Referring to FIG. 2, the linear translating component 40 is shown in greater detail within a housing 42. FIG. 3 shows a portion of the housing 42 removed and FIG. 4 shows the entire housing 42 removed. Removal of the housing 42 shows an anti-rotation device sleeve 44. The anti-rotation device sleeve 44 surrounds an anti-rotation device 50 (FIGS. 5-8), as described in detail herein. Since the anti-rotation device 50 is fixed to the linear translating component 40 in a manner that results in the anti-rotation device 50 translating with the linear translating component 40, the anti-rotation device 50 translates relative to an inner surface of the housing 42, with the sleeve 44 acting as an intermediary wear surface for the anti-rotation device 50. The anti-rotation device sleeve 44 has a low friction inner surface to reduce friction between the sleeve inner surface and the anti-rotation device 50, which translates therein. The low friction inner surface may result from the material of the sleeve 44 itself and/or by a coating disposed on the sleeve 44.

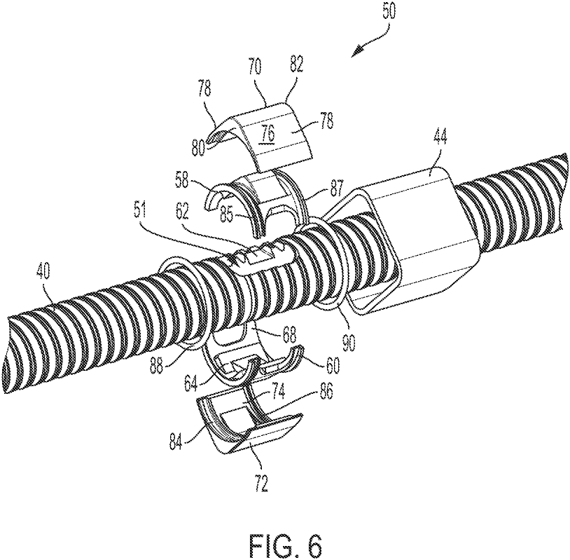

Referring now to FIGS. 5-7, the anti-rotation device 50 is shown. The anti-rotation device 50 is formed with multiple pieces and is mounted on the linear translating component 40 at a mounting location 51. The anti-rotation device 50 includes an inner clamshell assembly 52, an outer clamshell assembly 54, at least one spring element 88, 90 - and the sleeve 44 in some embodiments - as shown well in the disassembled view of FIG. 6. The embodiments disclosed herein provide the required anti-rotation kinematics to counteract loads on the linear translating component, while still allowing the use of standard inner tie rods and outer tie rods

The inner clamshell assembly 52 includes a first inner clamshell element 58 and a second inner clamshell element 60. The first and second inner clamshell elements 58, 60 may each be substantially hemispherical - relative to the linear translating component 40 - in some embodiments, such that they each surround approximately half of the linear translating component 40. However, the specific geometry of the first and second inner clamshell elements 58, 60 may vary in other embodiments. The mounting location 51 of the linear translating component 40 has a non-threaded portion with at least one protrusion and/or recess 62 which corresponds to at least one recess and/or protrusion 64 of the inner clamshell assembly 52. In particular, an inner surface 68 of the inner clamshell assembly 52 includes a geometry that interacts with the geometry of the mounting location 51 to fix the axial position and the rotational position of the inner clamshell assembly 52 relative to the linear translating component 40. In other words, the inner clamshell assembly 52 and the linear translating component 40 do not rotate or axially move relative to each other.

The outer clamshell assembly 54 includes a first outer clamshell element 70 and a second outer clamshell element 72. The first and second outer clamshell elements 70, 72 each include a substantially curved inner surface 74. The outer clamshell elements 70, 72 each include an outer surface 76 that does not form an arc of a circle. In particular, each outer surface 76 includes a pair of planar portions 78, but slight curvature is contemplated. Each outer clamshell element 70, 72 also extends from a first axial end 80 to a second axial end 82, with each axial end extending radially inwardly to axially retain the inner clamshell assembly 52 therein.

A first spring element groove 84 is defined within the inner surface 74 proximate the first axial end 80 of the outer clamshell elements 70, 72, and a second spring element groove 86 is defined within the inner surface 74 proximate the second axial end 82 of the outer clamshell elements 70, 72. Furthermore, a third spring element groove 85 is defined within the outer surface proximate the first axial end of the inner clamshell elements 58, 60, and a fourth spring element groove 87 is defined within the outer surface proximate the second axial end of the inner clamshell elements 58, 60. Each spring element groove 84-87 is dimensioned and positioned to receive a respective spring element therein. In particular, a first spring element 88 is positioned within the first spring element groove 84 and the third spring element groove 85, and a second spring element 90 is positioned within the second spring element groove 86 and the fourth spring element groove 87. Disposal of the spring elements 88, 90 between the inner clamshell assembly 52 and the outer clamshell assembly 54 de-lashes assemblies relative to each other. In the illustrated embodiments, the spring elements 88, 90 are O-rings. Alternatively, the spring elements 88, 90 may be a leaf spring, a coil spring or any other biasing element suitable for the particular application of use.

An outer surface of the first inner clamshell element 58 and/or the second inner clamshell element 60 includes at least one protrusion and/or recess 92 which corresponds to at least one recess and/or protrusion 94 of the outer clamshell assembly 54. In particular, the inner surface 74 of the outer clamshell assembly 54 includes a geometry that interacts with the geometry of the inner clamshell assembly 52 to fix the axial positon and the rotational position of the outer clamshell assembly 54 relative to the inner clamshell assembly 52. In other words, the outer clamshell assembly 54 and the inner clamshell assembly 52 do not rotate or axially move relative to each other.

As shown in FIGS. 5, 7 and 8, in the assembled condition of the anti-rotation device 50, the outer clamshell assembly 54 - as well as the inner clamshell assembly 52 and spring elements 88, 90 - are positioned within the anti-rotation device sleeve 44. As explained in detail above, the outer clamshell elements 70, 72 each include an outer surface 76 that does not form an arc of a circle. Therefore, in the assembled condition, the overall outer surface of the outer clamshell assembly 54 does not form a circle, cylinder or the like. Similarly, the inner surface of the sleeve 44 does not form a circular cross section, such that contact between the outer clam shell assembly 54 and the sleeve 44 resist torque and rotation of the anti-rotation device 50, and therefore the linear translating component 40. However, the anti-rotation device 50 translates with the linear translating component 40 during operation and relative to the sleeve 44.

It is to be appreciated that some embodiments do not include the sleeve 44. In such embodiments, the anti-rotation device 50 interacts directly with the housing 42. The inner surface of the housing 42 geometrically corresponds to the outer clamshell assembly 54, such that rotation and torque of the anti-rotation device 50 are resisted directly with the housing 42.

Although the overall outer geometry of the outer clamshell assembly 54, the sleeve 44 and the inner surface of the housing 42 are shown in a substantially square or rectangular configuration, it is to be appreciated that alternative non-circular geometries may be employed, as long as rotation and torque is resisted.

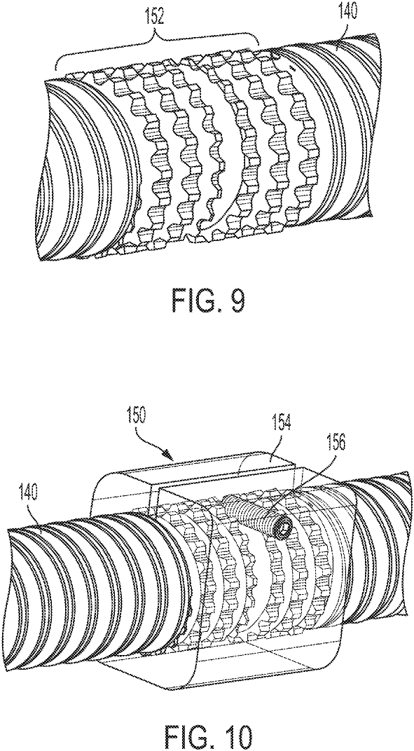

Referring to FIGS. 9 and 10, the linear translating component is shown according to another aspect of the disclosure and is generally referenced with numeral 140. The anti-rotation device is shown according to another aspect of the disclosure and is generally referenced with numeral 150. The axial center of the linear translating component 140 includes a knurled portion 152 and relief groove. The sleeve 44 is assembled into the housing 42 (FIG. 2) to be used as a wear and sliding surface to react the rotation torque as the linear translating component moves axially in the system, but as described above in connection with other embodiments, the anti-rotation device 150 may interact directly with an inner surface of the housing 42. A rectangular piece 154 is pressed to the knurled portion 152 and de-lashed with a set-screw 156 after installation in the housing 42, thereby allowing a precision setting for each system.

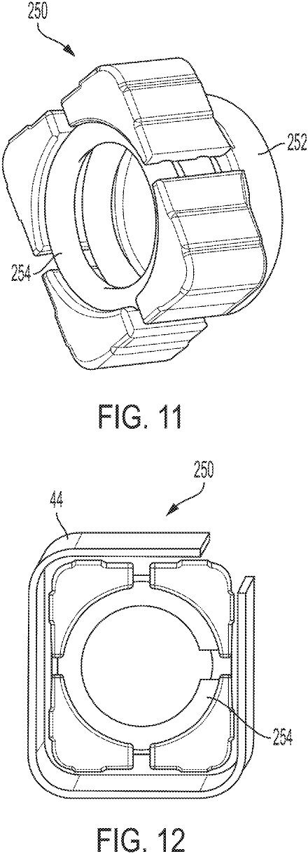

Referring to FIGS. 11 and 12, the anti-rotation device is shown according to another aspect of the disclosure and is generally referenced with numeral 250. The anti-rotation device 250 is pressed onto a knurled portion of the linear translating component on one end 252 and includes steel snap rings 254 or the like installed on the inner diameter of the other split end 254 to provide an outward force to delash the system to complete the load transfer path. The anti-rotation device 250 may also be used as a support bushing for screw bending if needed. The sleeve 44 is assembled into the housing 42 (FIG. 2) to be used as a wear and sliding surface to react the rotation torque as the linear translating component moves axially in the system, but as described above in connection with other embodiments, the anti-rotation device 250 may interact directly with an inner surface of the housing 42.

The embodiments disclosed herein allow for a reduction in packaging space required of EPS systems based on removal of several components, including a pinion, a pinion upper and lower bearing, a rack bearing, an adjuster plug, a lower rotor, and rack teeth in the case of a REPS system. Additionally, cost and complexity associated with manufacturing and assembly of the overall system is reduced with the anti-rotation device 50, 150, 250 disclosed herein. Furthermore, the embodiments disclosed herein utilize a non-cylindrical component that is adjustable to act as an anti-rotation device on a linear translating component, such as a ball screw, lead screw, or other component where it is beneficial or required to resist torque and rotation. This is also coupled with a mating wear component to meet NVH and friction requirements.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

What is claimed is:

1. A linear translating assembly comprising:
a housing;
a linear translating component moveable in an axial direction, wherein at least a portion of the length of the linear translating component is disposed within the housing; and
an anti-rotation device comprising:
an inner clamshell assembly at least partially surrounding the linear translating component at a mounting location of the linear translating component; and
an outer clamshell assembly at least partially surrounding the inner clamshell assembly,
wherein the anti-rotation device is disposed within the housing and is axially fixed to the linear translating component at the mounting location in a nonrotational manner relative to the linear translating component, wherein interaction between the anti-rotation device and the housing prevents rotation of the linear translating component.

2. The linear translating assembly of claim 1, further comprising a sleeve disposed between the outer clamshell assembly and the housing.

3. The linear translating assembly of claim 1, wherein the anti-rotation device and the housing are in direct contact with each other.

4. The linear translating assembly of claim 1, wherein the linear translating component is a ball screw.

5. The linear translating assembly of claim 1, wherein the linear translating component is a lead screw.

6. The linear translating assembly of claim 1, further comprising at least one spring element disposed between the inner clamshell assembly and the outer clamshell assembly to de-lash the anti-rotation device.

7. The linear translating assembly of claim 6, wherein the at least one spring element comprises a first spring element and a second spring element, wherein the first spring element is disposed within a first spring groove proximate a first axial end of the inner clamshell assembly and a first spring groove proximate a first axial end of the outer clamshell assembly, wherein the second spring element is disposed within a second spring groove proximate a second axial end of the inner clamshell assembly and a second spring groove proximate a second axial end of the outer clamshell assembly.

8. The linear translating assembly of claim 6, wherein the at least one spring element is one of an O-ring, a leaf spring and a coil spring.

9. The linear translating assembly of claim 1, wherein the inner clamshell assembly comprises a first inner clamshell element and a second inner clamshell element, the first and second inner clamshell elements each surrounding a portion of the linear translating component at the mounting location.

10. The linear translating assembly of claim 9, wherein at least one of the first inner clamshell element and the second inner clamshell element includes at least one protrusion and/or recess, wherein the mounting location of the linear translating component includes at least one protrusion and/or recess engaged with the protrusion(s) and/or recess(es) of the first and second inner clamshell element to axially and rotationally fix the linear translating component and the inner clamshell assembly relative to each other.

11. The linear translating assembly of claim 1, wherein the outer clamshell assembly comprises a first outer clamshell element and a second outer clamshell element, the first and second outer clamshell elements each surrounding a portion of the inner clamshell assembly.

12. The linear translating assembly of claim 11, wherein at least one of the first outer clamshell element and the second outer clamshell element includes at least one protrusion and/or recess, wherein the inner clamshell assembly includes at least one protrusion and/or recess engaged with the protrusion(s) and/or recess(es) of the first and second outer clamshell element to axially and rotationally fix the outer clamshell assembly and the inner clamshell assembly relative to each other.

13. The linear translating assembly of claim 1, wherein the linear translating assembly is part of an electric power steering system.

14. An anti-rotation device for a linear translating component comprising:
an inner clamshell assembly at least partially surrounding the linear translating component at a mounting location of the linear translating component, wherein the inner clamshell assembly comprises a first inner clamshell element and a second inner clamshell element;
an outer clamshell assembly at least partially surrounding the inner clamshell assembly, wherein the outer clamshell assembly comprises a first outer clamshell element and a second outer clamshell element, the first and second outer clamshell elements each surrounding a portion of the inner clamshell assembly; and
at least one spring element disposed between the inner clamshell assembly and the outer clamshell assembly to de-lash the anti-rotation device.

15. The anti-rotation device of claim 14, further comprising a sleeve disposed between the outer clamshell assembly and a surrounding housing.

16. The anti-rotation device of claim 14, wherein the at least one spring element comprises a first spring element and a second spring element, wherein the first spring element is disposed within a first spring groove proximate a first axial end of the inner clamshell assembly and a first spring groove proximate a first axial end of the outer clamshell assembly, wherein the second spring element is disposed within a second spring groove proximate a second axial end of the inner clamshell assembly and a second spring groove proximate a second axial end of the outer clamshell assembly.

17. The anti-rotation device of claim 14, wherein the at least one spring element is one of an O-ring, a leaf spring and a coil spring.

18. A steer-by-wire steering system for a vehicle comprising:
a housing;
a ball screw moveable in an axial direction and at least partially disposed within the housing; and
an anti-rotation device disposed proximate an outer surface of the ball screw at a mounting portion of the ball screw, wherein the anti-rotation device having at least one split to define a plurality of segments of the anti-rotation device, the plurality of segments flexible relative to each other, the anti-rotation device axially and rotationally fixed relative to the ball screw, the ball screw having a non-circular outer surface to interact with the housing in a non-rotatable manner;
a biasing element in contact with the anti-rotation device to bias the plurality of segments radially outward.

19. The steer-by-wire steering system of claim 18, wherein the ball screw has a knurled portion at the mounting location that the anti-rotation device is mounted to.

20. The steer-by-wire steering system of claim 18, wherein the ball screw includes a knurled outer surface at the mounting portion, the anti-rotation device having a plurality of segments joined by at least one flexing joint, the anti-rotation device having at least one retaining ring disposed within an inner surface of the plurality of segments.
